(19) United States
(12) Patent Application Publication
(10) Pub. No.: US 2007/0226914 A1
(43) Pub. Date: Oct. 4, 2007

(54) Archery arrow tool

(76) Inventor: Kurt Satayana, Luzerne, PA (US)

Correspondence Address: RATNERPRESTIA, P O BOX 980, VALLEY FORGE, PA, 19482-0980, US

(21) Appl. No.: 11/704,753

(22) Filed: Feb. 9, 2007

Related U.S. Application Data
(60) Provisional application No. 60/771,655, filed on Feb. 9, 2006.

(51) Int. Cl. B26B 11/00

(52) U.S. Cl. 7/158

(57) ABSTRACT

A hunting tool configured to be releasably coupled to a standard arrow shaft is provided. The hunting tool comprises an engagement portion for releasably coupling to the arrow shaft and a functional portion extending from the engagement portion. The functional portion of the hunting tool is selected from the group consisting of a saw, a hook, a knife, a strap attachment, an axe, a mirror, a magnifying glass, a spike, an arrow coupler, a slingshot, a cup, an alligator clip, a scent swab, an eyelet, a rake, a spade, and an illumination apparatus.

This application claims priority of U.S. Provisional Patent Application Ser. No. 60/771,655 filed Feb. 9, 2006.

### FIELD OF INVENTION

The present invention relates to tools, and more specifically to tools used for hunting game animals.

### BACKGROUND OF THE INVENTION

Archery hunters are faced with many challenges, such as the task of luring an animal within a 35 yard range or less from their position. The advent of portable tree stands has provided archery hunters with the opportunity to lure an animal within that range, however, archery hunting in a portable tree stand presents its own set of unique challenges to the bow hunter. In practice, once the hunter is settled into the tree stand, and he or she identifies shooting lanes to the forest floor, the hunter must tediously clear branches that obstruct the shooting lane or braches that invade their personal hunting space. A hunter may use a knife or a hook to clear obstructing tree branches. In addition to the above, a hunter utilizes a variety of tools to meet other challenges in the field. For example, hunters commonly use a flashlight to follow a trail of blood from a wounded animal. Hunters also use mock deer scrape and rub tools to attract an animal to the hunting site.

While having a variety of tools is certainly useful, archery hunters are faced with a competing interest of minimizing the number and weight of the tools and gear for meeting those challenges. For example, tree stand hunters must climb a tree with the bulky hunting gear strapped to their back or leg.

Therefore, a need exists to supply a useful, handy and convenient archery hunting tool kit. Because arrows are a basic requirement for an archery hunter, having the ability to convert arrows into field tools to assist the hunter with their challenges would be advantageous from a convenience perspective.

### SUMMARY OF THE INVENTION

The present invention provides a variety of attachments that can be attached to the end of an industry standard hunting arrow shaft equipped with an industry standard female arrow insert.

According to one exemplary embodiment a hunting tool configured to be releasably coupled to a standard arrow shaft is provided. The hunting tool comprises an engagement portion for releasably coupling to the arrow shaft and a functional portion extending from the engagement portion. The functional portion of the hunting tool is selected from the group consisting of a saw, a hook, a knife, a strap attachment, an axe, a mirror, a magnifying glass, a spike, an arrow coupler, a slingshot, a cup, an alligator clip, a scent swab, an eyelet, a rake, a spade, and an illumination apparatus.

According to another exemplary embodiment the hunting tool comprises a threaded post adapted to be releasably coupled to a threaded insert of the arrow shaft. The hunting tool further comprises a functional portion, other than an arrow head, extending from the threaded post, wherein the functional portion is a common hunting tool.

According to yet another exemplary embodiment a hunting tool kit is provided. The hunting tool kit comprises two hunting tools, wherein each hunting tool comprises an engagement portion for releasably coupling to a standard arrow shaft and a functional portion extending from the engagement portion. The functional portion of the hunting tools are selected from the group consisting of a saw, a hook, a knife, a strap attachment, an axe, a mirror, a magnifying glass, a multi-component tool, a spike, an arrow coupler, a slingshot, a cup, an alligator clip, a scent swab, an eyelet, a rake, a spade, and an illumination apparatus.

### BRIEF DESCRIPTION OF THE DRAWINGS

The invention is best understood from the following detailed description when read in connection with the accompanying drawing. It is emphasized that, according to common practice, the various features of the drawing may not be to scale. Included in the drawing are the following figures:

FIG. 1 is an exploded elevation view illustrating a standard hunting arrow (an end of which is shown cut-away) and a standard arrow head configured for threaded engagement with the end of the hunting arrow that is shown cut-away;

FIG. 2A is an elevation view of a saw attachment configured for threaded engagement with the hunting arrow of FIG. 1, according to one exemplary embodiment of the invention;

FIG. 2B is an elevation view of an axe attachment configured for threaded engagement with the hunting arrow of FIG. 1, according to one exemplary embodiment of the invention;

FIG. 2C is an elevation view of a knife attachment configured for threaded engagement with the hunting arrow of FIG. 1, according to one exemplary embodiment of the invention;

FIG. 2D is an exploded elevation view of another saw attachment and a handle configured for threaded engagement with the saw attachment, wherein a portion of the handle is shown cut-away to reveal an internal threaded region;

FIG. 3 is an elevation view of a hook attachment configured for threaded engagement with the hunting arrow of FIG. 1, according to another exemplary embodiment of the invention;

FIG. 4 is a perspective view of a bowed saw attachment configured for threaded engagement with the hunting arrow of FIG. 1, according to another exemplary embodiment of the invention;

FIG. 5 is an elevation view of an eyelet attachment configured for threaded engagement with the hunting arrow of FIG. 1, according to another exemplary embodiment of the invention;

FIG. 6 is a perspective view of a scent cup attachment configured for threaded engagement with the hunting arrow of FIG. 1, according to another exemplary embodiment of the invention;

FIG. 7 is an elevation view of a spike attachment configured for threaded engagement with the hunting arrow of FIG. 1, according to another exemplary embodiment of the invention;

FIG. 8 is an elevation view of an optical attachment configured for threaded engagement with the hunting arrow of FIG. 1, according to another exemplary embodiment of the invention;

FIG. 9 is a perspective view of a rake attachment configured for threaded engagement with the hunting arrow of FIG. 1, according to another exemplary embodiment of the invention;

FIG. 10 is an elevation view of an alligator clip attachment configured for threaded engagement with the hunting arrow of FIG. 1, according to another exemplary embodiment of the invention;

FIG. 11 is a perspective view of a scent swab attachment configured for threaded engagement with the hunting arrow of FIG. 1, according to another exemplary embodiment of the invention;

FIG. 12 is a perspective view of a spade attachment configured for threaded engagement with the hunting arrow of FIG. 1, according to another exemplary embodiment of the invention;

FIG. 13 is a perspective view of a slingshot attachment configured for threaded engagement with the hunting arrow of FIG. 1, according to another exemplary embodiment of the invention;

FIG. 14A is an elevation view of an arrow coupler according to another exemplary embodiment of the invention;

FIG. 14B is an exploded elevation view of two arrow couplers of FIG. 14A and three extension rods, wherein each arrow coupler is configured to be threadedly coupled between adjacent extension rods, according to another exemplary embodiment of the invention;

FIG. 15 is a perspective view of an illumination attachment configured for threaded engagement with the hunting arrow of FIG. 1, according to another exemplary embodiment of the invention;

FIG. 16 is a plan view of a strap attachment configured for threaded engagement with the hunting arrow of FIG. 1, according to another exemplary embodiment of the invention;

FIG. 17 is a plan view of an illumination attachment, according to another exemplary embodiment of the invention, whereby the illumination attachment is configured for releasable attachment to the hunting arrow of FIG. 1; and

FIG. 18 is an elevation view of a multi-function tool attachment configured for threaded engagement with the hunting arrow of FIG. 1, according to another exemplary embodiment of the invention.

### DETAILED DESCRIPTION OF THE INVENTION

The invention will next be illustrated with reference to the figures. Such figures are intended to be illustrative rather than limiting and are included herewith to facilitate explanation of the present invention. The figures are not necessarily to scale, and are not intended to serve as engineering drawings.

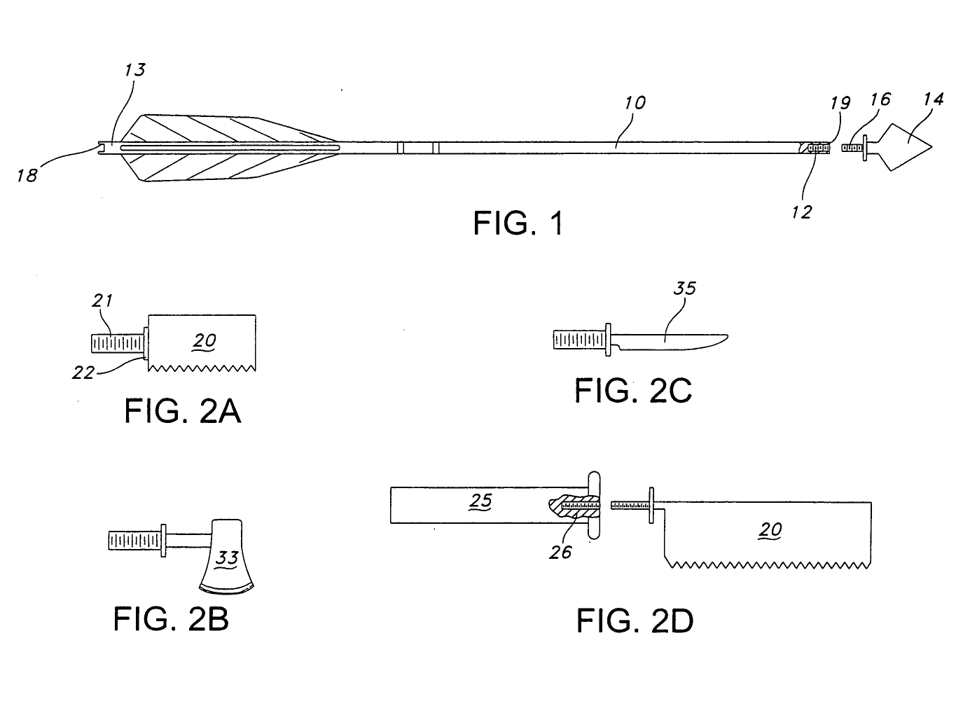

In FIG. 1, an exploded view of an industry standard hunting arrow 10 is illustrated. The hunting arrow 10 includes an elongated shaft, a female threaded insert 12 disposed on end of the shaft, and a bow slot 18 disposed on an opposing end 13 of the shaft. The female threaded insert 12 includes an industry standard female #8-32 screw thread, according to one exemplary embodiment. A standard arrow head 14 is releasably and threadedly coupled to the female threaded insert 12 of the arrow 10. It follows that the industry standard arrow head 14 includes a male #8-32 screw thread 16.

The present invention provides a variety of hunting tools configured to be releasably mounted to the female threaded insert 12 of the industry standard hunting arrow shaft, in lieu of arrow head 14. Each exemplary hunting tool, with various exceptions, includes an engagement portion 21 (see FIG. 2A), and a flange 22 positioned at an end of the engagement portion 21 (see FIG. 2A). The flange 22 is provided to abut the exposed end 19 of the arrow 10 shown in FIG. 1, in the interest of preserving the threads of the female threaded insert 12. The engagement portion 21 is optionally a #8-32 inch industry standard male screw interface for engaging the #8-32 threads of the female threaded insert 12 of the arrow shaft, in accordance with the present invention. However, it should be understood that engagement between the arrow shaft and the hunting tool is not limited to mechanical threads. For example, the hunting tool and arrow shaft may be releasably connected by a fastener, Velcro, a plug feature, a snap feature, a mechanical connector, or any other connection means known in the art. Accordingly, the engagement portion 21 of a hunting tool is not limited to a single embodiment.

Each exemplary hunting tool also includes a functional portion extending from the engagement portion. The functional portion (e.g., saw blade 20 of FIG. 2A, axe 33 of FIG. 2B, knife 35 of FIG. 2C) serves a utilitarian purpose, such as cutting, sawing, piercing, providing light, holding liquid, and so forth. The hunting tools are compact and can be easily carried in a field backpack or fanny pack. All of the hunting tools outlined below are preferably composed of a robust material, such as aluminum or an aluminum-based material, or a plastic, for example. Exemplary embodiments of the hunting tools are illustrated in the appended figures.

In FIG. 2A, a saw attachment 20 is shown for releasable attachment to the arrow 10 of FIG. 1. The functional portion of the saw attachment, i.e., the serrated blade 20, is preferably sharp to ensure a quick and easy cut of a tree limb or branch with minimal effort. The engagement portion 21 of the saw attachment 20 is configured for releasable threaded engagement with the female threaded insert 12 hunting arrow, as described above. A flange 22 is disposed between the male threaded region 21 and the saw blade, as described above. The flange 22 is provided to abut the exposed end of the arrow 10 shown in FIG. 1, in the interest of preserving the threads of the female threaded insert 12. The flange 22 and the engagement portion are also shown on the hunting tools illustrated in FIGS. 2A-12, 14A-16 and 18, and are not described hereinafter.

Combining the saw attachment 20 with the arrow 10 provides the hunter with a long saw for removing the obstructing tree branches that are out of arms reach. Ordinarily, a hunter would have to work around the obstructing tree branch, which may compromise the shooting lane. By way of non-limiting example, the saw attachment 20 may be approximately 4 inches long, and the arrow may be 30 inches long, thereby creating a saw having a 34 inch length. It should be understood that the saw blade of the saw is only 4 inches long in this example. Of course, the arrow and the saw attachment 20 may be of any desired length.

In FIGS. 2B and 2C, the blade of the hunting tool is sharp and smooth. In FIG. 2B an axe attachment 33 is shown, and in FIG. 2C a knife attachment 35 is shown. Either the knife attachment 35 or the axe attachment 33 can be used to shave the bark from the tree to expose the bright bare wood for simulating a ‘rub.’ The shavings may be left on the tree to simulate a fresh rub. The combined length of the arrow 10 and knife attachment or the axe attachment permit the hunter to maintain a safe distance from the tree while preparing the mock rub with the sharp blade, thereby reducing the potential for depositing human scent onto the tree.

As background, rubs and scrapes are utilized by adult male deer (i.e., bucks) to facilitate the mating process. Bucks mark their territories with rubs and scrapes. A rub is an area on a tree where a buck removed the bark of the tree with his antlers. In a well traveled area, such as where deer trails intersect, a male deer will deposit his scent on a low hanging branch or tree trunk by rubbing his antlers on the tree. A scrape is an area of the ground ranging from 12 inches to 72 inches in diameter where the buck has cleared leaves and brush. The buck urinates over his tarsal and metatarsal glands of his legs onto the scrape.

The scrape and rub scents attract breeding does to the area. The doe urinate on the scrape, thereby informing the buck where a particular doe is in her breeding cycle. If another male deer is trying to leave scrape and rub scents in a dominate buck area, the dominate buck will attempt to prevent the inferior buck from breeding with the does. Accordingly, the dominant buck will frequent the area looking to challenge the male intruder.

Hunters commonly create mock scrapes by clearing an area of the forest floor and distributing doe urine over that cleared area, to create the illusion that another deer is in the area. The mock scrape causes a buck to frequent that hunting area. Mock buck scrapes create a great advantage to the archery hunter, who must lure the buck within a 35 yard range or less from their position. Successful hunters prepare the mock scrape such that the buck can not detect a human scent, because the human scent would cause the buck to vacate the area.

Hunters also create mock rubs by abrading the surface of a tree and distributing deer scent and/or urine over the abraded surface. The sharp edge of the knife attachment 35 or the axe attachment 33 can be used to shave the bark from the tree to expose the bright bare wood for simulating a ‘rub’, while permitting the hunter to remain a safe distance away from the tree, by virtue of the long arrow shaft 10, to avoid depositing a human scent onto the tree. Preparing the mock rub with the sharp and smooth knife edge promotes the appearance that the buck rub is being tended on a regular basis by another buck. It should be understood that the knife attachment 35 or the axe attachment 33 can also be used to remove tree branches, or for any other purpose.

In FIG. 2D, a handle 25 configured for use with the saw attachment 20, knife attachment 35 or the axe attachment 33, or any other of the attachments described herein, is illustrated. In the embodiment shown in FIG. 2D, the engagement portion of the saw attachment is configured to be threadedly coupled to the female threaded region 26 of the handle 25. The handle 25 is particularly useful in situations where the hunter wishes to use a hunting tool without combining the tool with an arrow shaft. It should be understood that the handle 25 may be used with any hunting tool described herein, and is not limited for use with any specific attachment.

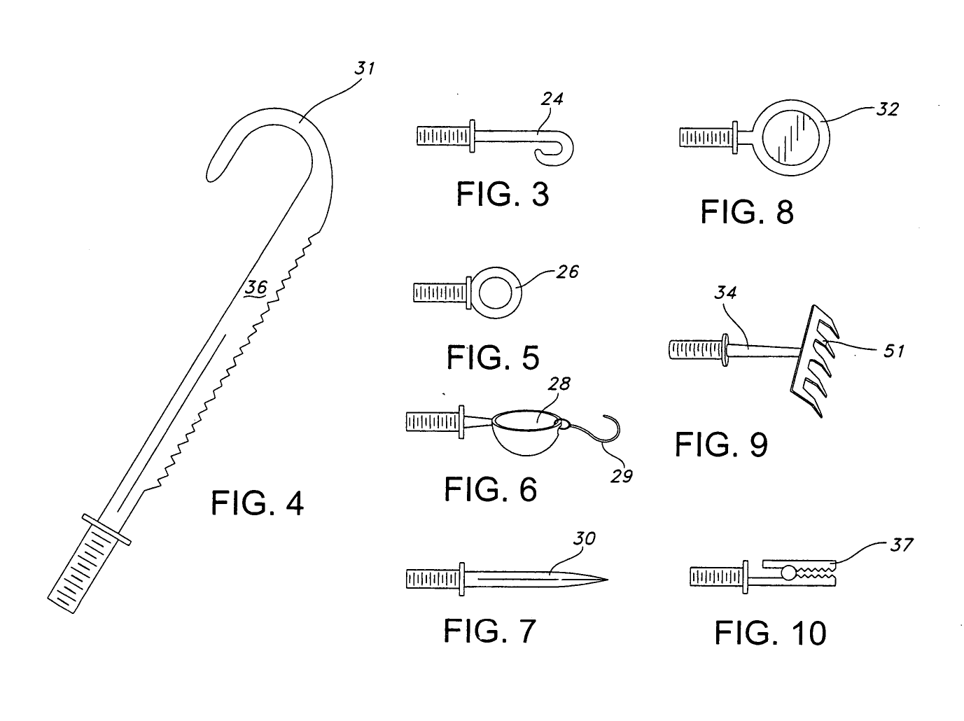

In FIG. 3, a hook attachment 24 configured for releasable attachment to the arrow 10 is shown. In practice, a hunter manipulates the hook attachment 24 to retrieving an obstructing branch that is out of arms length. The hunter then pulls the branch so that he or she may grab the branch and break it by hand. According to one exemplary embodiment, the hook attachment 24 is approximately 4 inches long and includes a 1½ inch diameter hook, for example. It should be understood that the shape and length of the hook is not limited to the illustration shown.

In FIG. 4, a bowed saw attachment 36 configured for releasable attachment to the arrow 10 is shown. The bowed saw attachment is a combination of the saw attachment of FIG. 2A and the hook attachment of FIG. 3. The bowed saw attachment includes a serrated blade for sawing tree limbs, as described with reference to FIG. 2A. Furthermore, the saw blade includes a curved end 31 for retrieving a tree branch that is out of arms length. By combining the hook and the saw, a user may retrieve an obstructing tree branch and saw it off utilizing only one attachment tool. Moreover, combining the hook and the saw reduces the number of hunting tools that are required to remove an obstructing tree branch. Although not shown, the blade of the attachment may also be smooth and sharp.

In FIG. 5, a drag line eyelet attachment 26, otherwise referred to as an eyelet attachment, configured for releasable attachment to the arrow 10 is shown. In practice, the hunter threadedly couples the engagement portion of the eyelet attachment 26 to the female insert 12 of the arrow 10, and ties a string to the eyelet 26. A swap of cloth (not shown) that has doe urine scent applied thereto is tied to the opposing end of the string. The hunter walks to their hunting location dragging the urine-soaked cloth through the forest brush, in an effort to attract a buck that will follow the scent trail. The eyelet attachment 26 allows the archery hunter to drag the urine-soaked cloth sufficiently away from their own foot steps to minimize the possibilities of being detected by the deer.

In FIG. 6, a scent cup attachment 28 configured for releasable attachment to the arrow 10 is shown. In practice, a hunter pours male deer urine into the scent cup attachment 28, and applies the urine to the mock scrape and/or the mock rub while remaining at a distance therefrom, thereby reducing the possibility of depositing a human scent. The scent cup may be an integral unit with the engagement portion as shown, or, alternatively, the scent cup may include a removable plastic cup (not shown). The scent cup attachment 28 optionally includes a drying hook 29 for hanging the scent cup attachment 28 to dry following its use.

In FIG. 7, a spike attachment 30 configured for releasable attachment to the arrow 10 is shown. In use, the spike attachment 30 is adapted to be driven into the ground to serve as a location marker for retrieving a fleeing wounded animal. By using the spike attachment, a hunter avoids damaging an expensive razor hunting broad head tip by driving it into the ground. In common hunting practice, a wounded animal leaves a blood trail along the forest brush and the archery hunter follows that blood trail to retrieve the animal. It is common that the blood trail ends and the hunter must circle the end of the blood trail. The archery hunter marks the end of the blood trail by driving an arrow into the ground. Typically, the hunter circles the area within 20 yards of the protruding arrow in an attempt to locate the wounded animal. By virtue of the spike attachment 30, the hunter avoids damaging an expensive razor hunting broad head tip by driving it into the ground. According to one exemplary embodiment, the spike attachment 30 is approximately 4 inches long and has a sharp point to pierce the ground.

In FIG. 8, an optical attachment 32 configured for releasable attachment to the arrow 10 is shown. The optical attachment 32 may be a mirror, for example, for enabling the hunter to view a deer located behind the hunter. In this fashion, the hunter can see the deer without turning his or her body around, which may alert the deer to the hunter's presence. In another exemplary embodiment, the optical attachment 32 may be a magnifying glass, to enable the hunter to view a small item on the ground.

In FIG. 9, a scrape rake attachment 34 configured for releasable attachment to the arrow 10 is shown. Using the scrap rake attachment 34, the hunter may clears leafs and sticks from the ground to create a mock scrape, while maintaining a safe distance away from the mock scrape to avoid depositing his or her scent. The scrape rake attachment 34 represents a vast improvement over common hunting practice. Most hunters simulate a buck scrape by simply kicking away leaves and sticks to create a clearing area, and applying male deer urine over that area. However, those hunters have inevitably left their scent on the mock scrape.

According to this exemplary embodiment, the scrape rake attachment 34 is a rigid metal rake with a plurality of prongs 51 (five prongs are illustrated in FIG. 9). The width of the exemplary rake attachment 34 is 3 inches and the length of the rake attachment 34 is 2½ inches, for example, or any other desired dimension.

In FIG. 10, an alligator clip attachment 37 configured for releasable attachment to the arrow 10 is shown. The alligator clip attachment 37 may be a standard alligator clip. In one exemplary use, a cloth is clipped to the alligator clip 37, the cloth is thereafter soaked in urine, and applied directly to a scrape or rub. Positioning the alligator clip and cloth on the end of the arrow 10, and away from the body of the hunter, reduces the possibility of human scent laydown onto the cloth. The alligator clip attachment 37 may also be used by teams of hunters positioned in adjacent trees for passing various items between them.

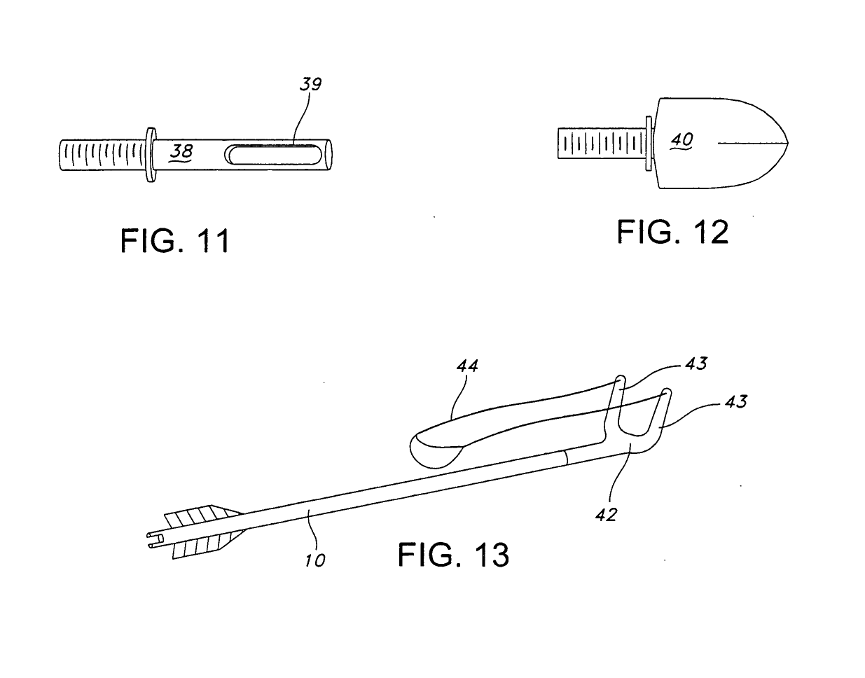

In FIG. 11, a scent swab attachment 38 configured for releasable attachment to the arrow 10 is shown. The scent swab attachment 38 includes a slot 39 through which a swap or cloth may be inserted. Similar to the alligator clip attachment 37, in practice, urine may be applied directly to the cloth away from the body of the hunter, to reduce the possibility of human scent laydown onto the urine-soaked cloth.

In FIG. 12, a spade attachment 40 configured for releasable attachment to the arrow 10 is shown. The spade attachment 40 may be used to remove leaves and dirt from the ground to create a mock scrape. The spade attachment 40 may also be used to distribute urine, or other deer scent, onto a scrape or a rub.

In FIG. 13, a sling shot attachment 42 configured for releasable attachment to the arrow 10 is shown. Although not shown, the sling shot attachment 42 includes an engagement portion for releasably coupling with the arrow 10. According to one exemplary embodiment, the sling shot attachment 42 comprises two vertical posts 43 extending from the engagement portion. An elastic band 44 is tied between the vertical posts 43. In practice, a hunter could utilize the slingshot attachment 42 to scare off other animals that could potentially ward off the deer. The operation of a slingshot is commonly understood.

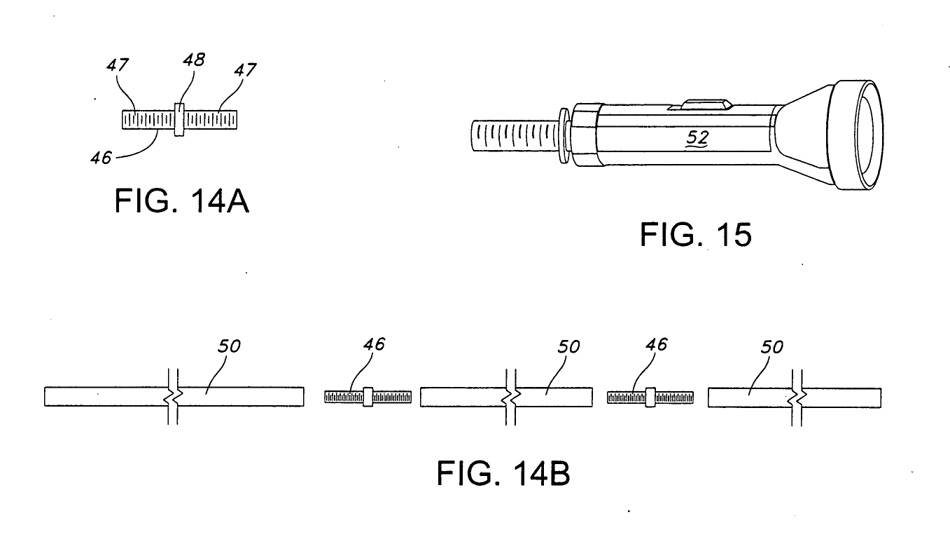

In FIG. 14A, an arrow coupler 46 for interconnecting two arrows 10 is shown. According to one exemplary embodiment, the arrow coupler 46 comprises two opposing engagement portions 47. The engagement portions 47 are each optionally a #8-32 male screw thread. A flange 48 is positioned between the engagement portions 47 for abutting against the ends 19 of the arrow shafts 10. The engagement portions 47 may be 1 inch long, for example. In one embodiment, one of the engagement portion 47 is a right handed thread, while the opposing 47 is a left handed thread, for limiting or preventing the interconnected arrows from detaching.

According to one exemplary use of the invention, the arrow coupler 46 and two arrows 10 are used in conjunction with a long cable to retrieve an item that has fallen to the ground. Such a cable may be a Master Retrieval Line, as disclosed in U.S. Patent Application Ser. No. 60/749,528, which is incorporated herein by reference in its entirety.

As described in U.S. Patent Application Ser. No. 60/749,528, a Master Retrieval Line is used by hunters in a tree stand or otherwise elevated position to recover items that have fallen to the ground. In the event that a hunter drops something from an elevated position and that item falls far from the base of the tree, a hunter may tie the Master Retrieval Line described in '528 to the end of a plurality of interconnected arrows 10 (which are connected by the arrow coupler 46). A retrieval component, such as a hook, adhesive, or a magnet, for example, is mounted to the an end of the Master Retrieval Line for capturing the fallen item.

In practice, the tree stand hunter ties the Master Retrieval Line to the interconnected arrows 10, and deploys the retrieval component (e.g., hook, adhesive, or magnet) onto the fallen item. Once the retrieval component catches or adheres to the fallen item, the hunter spools the Master Retrieval Line to retrieve the fallen item. Attaching the Master Retrieval Line to the interconnected arrows 10 permits the hunter to retrieve an item that has fallen a greater distance from the base of the tree, than using the Master Retrieval Line alone.

The arrow coupler 46 is not limited to coupling two arrow shafts 10 together. In another exemplary embodiment, the arrow coupler 46 is used for threadedly coupling a plurality of extension rods 50, as shown in FIG. 14B, and explained in greater detail below. Although not illustrated, both ends of each extension rod 50 include an internal female threaded insert for coupling with the engagement portion 47 of the arrow coupler 46.

The rods 50 are particularly advantageous for rifle hunters who would wish to use the portable attachment tools described herein, but do not carry arrows. It follows that the hunting tools having engagement portions may be coupled to an extension rod 50, instead of an arrow 10, for the same general purposes described above, such as sawing a tree branch, mounting a flashlight, creating a mock rub, and so forth.

In FIG. 15, an illumination attachment 52 configured for releasable attachment to the arrow 10 is shown. According to one exemplary embodiment, the illumination attachment 52 is a flashlight. The flashlight is useful for finding a blood trail left by a fleeing wounded animal. Under normal circumstances, the blood trail of a fleeing animal may be difficult to identify because either the blood trail of a running animal is sporadic, daylight has faded, or the forest ground is covered by colored leafs which conceal the blood. Thus, a flashlight is commonly used to locate the blood trail.

Although not shown, the illumination attachment 52 may be equipped with interchangeable lenses to assist archery hunters in a particular situation. The lenses may be clear, red or blue colored. For example, a blue lens may be attached to the flashlight for following a blood trail in darkness, since a blue light illuminates blood.

The illumination attachment 52 includes an engagement portion for attachment to the female threaded insert 12 of the arrow 10. By coupling the illumination attachment 52 to the arrow 10, the archery hunter may keep the light close to the ground which will aid in illuminating the blood on the ground. Also, keeping the light close to the ground minimizes possible detection of a hunter's approach to a wounded animal. The ability to follow the blood trail while keeping a low profile upon stalking the animal greatly improves the chances of animal recovery.

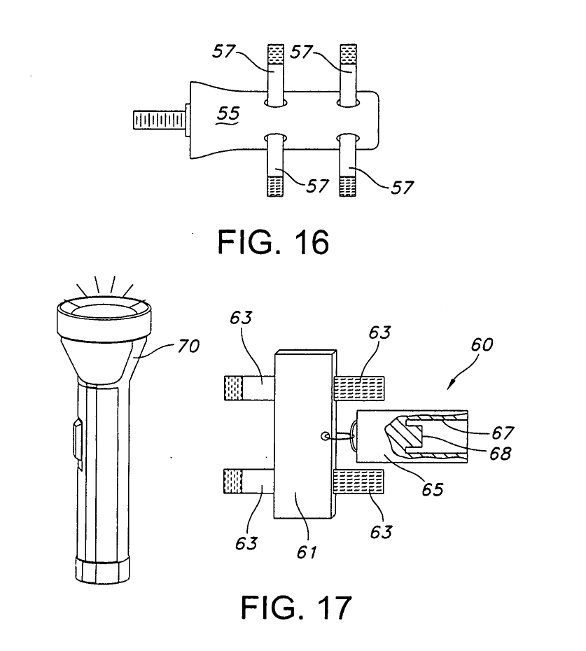

In FIG. 16, a strap attachment 55 configured for releasable attachment to the arrow 10 is shown. According to this exemplary embodiment, the strap attachment 55 includes an engagement portion, a rigid plate extending from the engagement portion, and a plurality of Velcro straps 57 attached to the rigid plate. The Velcro straps 57 are provided for releasably coupling the flashlight or hand tool to the rigid plate. In practice, an object, such as a flashlight, is positioned on the rigid plate, and the Velcro straps 57 are tied around the flashlight and fastened together retaining the flashlight against the rigid plate. The strap attachment may also be utilized to retain a saw, a hook, a knife, an axe, a mirror, a magnifying glass, a cup, a rake, and a spade, for example.

In FIG. 17, another exemplary embodiment of a strap attachment 60 is shown. Similar to the strap attachment 55 of FIG. 16, the strap attachment 60 includes a rigid plate 61 and a plurality of Velcro straps 63 for retaining a flashlight 70, or other item, as described with reference to FIG. 16. However, unlike strap attachment 55, the strap attachment 60 does not include an engagement portion for engagement with the female threaded insert 12 of the arrow 10. In this exemplary embodiment, the strap attachment 60 includes a crown 65 tied to the rigid plate 61. A bore 67 is defined along a portion of the length of the crown 65. In use, the bore 67 of the crown 65 is positioned over the end 13 of the arrow 10 shown in FIG. 1A. A rib 68 is disposed at the base of the bore 67 for engaging with the bow slot 18 of the arrow 10. Engagement between the rib 68 and the bow slot 18 maintains the flashlight, or other item, in a stable position with respect to the arrow 10.

This strap attachment 60 is particular useful for field dressing an animal after sundown. More specifically, after sundown the hunter must field dress the animal with the assistance of artificial light. A problem exists of directing the artificial lighting in the proper location to aid the hunter in dressing the animal. The strap attachment 60 solves the aforementioned problem.

According to one exemplary use of the strap attachment 60, a hunter threadedly couples the spike attachment 30 shown in FIG. 7 to the female threaded insert 12 of the arrow 10, and drives the spike 30 into the ground, such that the arrow 10 protrudes up from the ground. Thereafter, the hunter straps a flashlight 70 to the rigid plate 61 of the strap attachment 60, and secures the Velcro straps 63 around the flashlight 70. The hunter then positions the crown 65 of the strap attachment 60 over the end 13 of the arrow 10, and engages the bow slot 18 of the arrow 10 with the rib 68 of the crown 65. The hunter is then able to direct the light beam of the flashlight 70 toward the animal for field dressing the animal. Because the rigid plate 61 is tied to the crown 65, the flashlight 70 may be easily moved to any desired position.

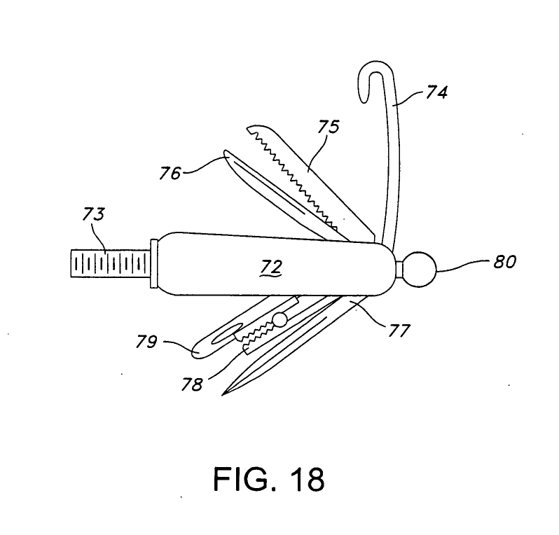

In FIG. 18, a multifunction tool attachment 72, similar to a Swiss pocket army knife or multifunction pocket tool, is shown. The multifunction tool attachment 72 includes a hook 74 similar to hook 24 of FIG. 3, a saw 75 similar to saw 20 of FIG. 2A, a knife 76 similar to knife 35 of FIG. 2C, an alligator clip 78 similar to the alligator clip 37 of FIG. 10, and a scent swab 79 similar to scent swab 38 of FIG. 11, and a spike 77 similar to spike 30 of FIG. 7.

Of course, the multifunction tool attachment 72 may incorporate any number of hunting tools, and is not limited to the illustration shown. Similar to a Swiss pocket army knife, the individual tools of the multifunction tool attachment 72 fold out of the body of the multifunction tool attachment 72, as shown. A ring 80 is mounted to the end of the multifunction tool attachment 72, for attaching a flashlight, keys, or any other item to the multifunction tool attachment 72.

Like the previous hunting tools, the multifunction tool attachment 72 includes an engagement portion 73 for threaded engagement with the female threaded insert 12 of an arrow 10. The multifunction tool attachment 72 provides the archery hunter with access to multiple tools within a single device. The individual tools that may be configured with this device are the following: saw, knife, hook, alligator clip, spike, eyelet, scent swab, scent cup, and so forth.

The present invention includes all of the hunting tools discussed above and each hunting tool (except strap attachment 60) includes an engagement portion for connection with a female threaded insert of a standard hunting arrow. The dimensions of the female threaded insert would include all dimensions known to be used with conventional archery equipment and arrows for all types of arrow materials (e.g., aluminum, carbon, wood, or hybrid combination thereof).

Many of these dimensions are included below as examples of those used for equipment and arrows sold by Easton of Salt Lake City, Utah, USA.

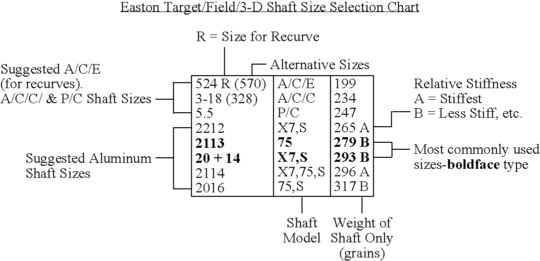

Inserts/external connectors to accept industry standard arrows tips/broad heads are #8-32 female threads. This includes all types of arrows: carbon, aluminum and mix composite type arrows that are made of both aluminum and carbon.

While exemplary embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed is:

1. A hunting tool configured to be releasably coupled to a standard arrow shaft, said hunting tool comprising an engagement portion for releasably coupling to the arrow shaft and a functional portion extending from the engagement portion, wherein said functional portion of said hunting tool is selected from the group consisting of a saw, a hook, a knife, a strap attachment, a multi-component tool, an axe, a mirror, a magnifying glass, a spike, an arrow coupler, a slingshot, a cup, an alligator clip, a scent swab, an eyelet, a rake, a spade, and an illumination apparatus.

2. The hunting tool of claim 1, wherein said engagement portion of said hunting tool is a threaded post adapted to be releasably coupled to a threaded insert of the arrow shaft.

3. The hunting tool of claim 2, wherein said threaded post comprises a #8-32 Unified Coarse Thread adapted to be releasably coupled to a #8-32 Unified Coarse Thread of the arrow shaft.

4. The hunting tool of claim 1 further comprising a flange positioned adjacent to the engagement portion of the hunting tool, said flange being positioned to limit the engagement between the hunting tool and the arrow shaft.

5. The hunting tool of claim 1, wherein the strap attachment is configured to retain a tool selected from the group consisting of an illumination apparatus, a saw, a hook, a knife, an axe, a mirror, a magnifying glass, a cup, a rake, and a spade.

6. The hunting tool of claim 5, wherein the strap attachment comprises a rigid plate and a plurality of Velcro straps mounted to the rigid plate, said straps being configured to releasably retain the tool in place.

7. The hunting tool of claim 1, wherein the multi-component tool comprising at least two functional portions.

8. The hunting tool of claim 1, wherein an end of the saw is curved in the shape of a hook.

9. The hunting tool of claim 1, wherein the slingshot comprises two posts that are configured to be coupled to the arrow shaft and an elastic band coupled between the posts.

10. The hunting tool of claim 1, said arrow coupler comprising a threaded shaft having opposing ends, wherein each threaded end of said shaft is configured to receive an arrow shaft for combining two arrow shafts together.

11. The hunting tool of claim 1, wherein said illumination apparatus is a flashlight.

12. The hunting tool of claim 1, wherein said scent swab comprises a shaft having an opening formed therein for receiving a cloth or swab.

13. A hunting tool configured to be releasably coupled to a standard arrow shaft, said hunting tool comprising:
a threaded post adapted to be releasably coupled to a threaded insert of the arrow shaft; and
a functional portion, other than an arrow head, extending from the threaded post, wherein said functional portion is a common hunting tool.

14. The hunting tool of claim 13, wherein said threaded post of said hunting tool comprises a #8-32 Unified Coarse Thread.

15. The hunting tool of claim 13, wherein said functional portion of said hunting tool is selected from the group consisting of a saw, a hook, a knife, a strap attachment, an axe, a mirror, a magnifying glass, a spike, an arrow coupler, a slingshot, a cup, an alligator clip, a scent swab, an eyelet, a rake, a spade, and an illumination apparatus.

16. A hunting tool kit comprising:
a first hunting tool including an engagement portion for releasably coupling to a standard arrow shaft and a functional portion extending from the engagement portion; and
a second hunting tool including an engagement portion for releasably coupling to a standard arrow shaft and a functional portion extending from the engagement portion,
wherein said functional portion of said first hunting tool and said second hunting tool is selected from the group consisting of a saw, a hook, a knife, a strap attachment, an axe, a mirror, a magnifying glass, a multi-component tool, a spike, an arrow coupler, a slingshot, a cup, an alligator clip, a scent swab, an eyelet, a rake, a spade, and an illumination apparatus.

17. The hunting tool kit of claim 16 further comprising a standard arrow shaft having an engagement portion configured for selectively receiving the first hunting tool and the second hunting tool.

18. The hunting tool kit of claim 16 further comprising a strap attachment including a rigid plate and a plurality of Velcro straps mounted to the rigid plate, said straps being configured to releasably retain a hunting tool in place.
